(19) United States
(12) Patent Application Publication
(10) Pub. No.: US 2005/0159060 A1
(43) Pub. Date: Jul. 21, 2005

(54) Composite laminate and method for making the same

(76) Inventor: Ten-Po Shao, Yung-Kang City (TW)

Correspondence Address: FROMMER LAWRENCE & HAUG, 745 FIFTH AVENUE- 10TH FL., NEW YORK, NY, 10151, US

(21) Appl. No.: 10/759,842

(22) Filed: Jan. 16, 2004

(51) Int. Cl. B32B 3/00

(52) U.S. Cl. 442/59; 442/286

(57) ABSTRACT

A composite laminate includes a fabric sheet which is surface-treated with a diamine-containing surface agent, a thermoplastic sheet, and a polyurethane elastomer film interposed between the fabric sheet and the thermoplastic sheet. The fabric sheet, the polyurethane elastomer film, and the thermoplastic sheet are thermally pressed to form a stack in such a manner that the polyurethane elastomer film penetrates into the fabric sheet, reacts with the surface agent to form a —CONH bonding therebetween, and is bonded to the thermoplastic sheet.

### BACKGROUND OF THE INVENTION

1. Field of the Invention

This invention relates to a composite laminate, more particularly to a composite laminate having a fabric sheet bonded to a thermoplastic sheet through a polyurethane elastomer film and to a method for making the same.

2. Description of the Related Art

Articles, such as the housing of a computer or a cellular phone, the upper of a shoe, and a golf bag, are normally made from a composite laminate that includes a carbon fiber-made fabric laminate consisting of a plurality of fabric sheets, each of which is impregnated with epoxy resin. The fabric laminate is subsequently coated with a polyurethane layer thereon by spraying repeatedly polyurethane thereto so as to obtain a smooth surface on the fabric sheet. The fabric laminate is dried after each spraying operation, which results in a relatively long time to prepare the fabric laminate for the next spraying operation. Moreover, hand stitching is difficult for the composite laminate clue to the presence of epoxy resin in the composite laminate.

Another conventional composite laminate includes a fabric sheet, a thermoplastic sheet adhesively bonded to one side of the fabric sheet through an adhesive, and a polyurethane film coated on an opposite side of the fabric sheet to obtain a smooth surface on the opposite side of the fabric sheet. The conventional composite laminate is disadvantageous in that the aforesaid adhesive takes a relatively long time to harden, that the fabric sheet tends to peel off from the thermoplastic sheet, and that bubbles are formed in the adhesive due to the presence of solvent in the adhesive, which has an adverse effect on the appearance of the article to be made from the composite laminate.

### SUMMARY OF THE INVENTION

Therefore, the object of the present invention is to provide a composite laminate that is capable of overcoming the aforesaid drawbacks of the prior art.

According to one aspect of the present invention, there is provided a composite laminate that includes: a fabric sheet which is surface-treated with a amine-containing surface agent; a thermoplastic sheet; and a polyurethane elastomer film interposed between the fabric sheet and the thermoplastic sheet. The fabric sheet, the thermoplastic sheet and the polyurethane are thermally pressed to form a stack in such a manner that the polyurethane elastomer film penetrates into the fabric sheet, reacts with the surface agent to form a —CONH bonding therebetween, and is bonded to the thermoplastic sheet.

According to another aspect of the present invention, there is provided a method for making a composite laminate. The method includes the steps of: stacking a fabric sheet, a polyurethane elastomer film and a thermoplastic sheet together to form a stack, the polyurethane elastomer film being disposed between the fabric sheet and the thermoplastic sheet; and hot pressing the stack in such a manner so as to permit penetration of the polyurethane elastomer film into the fabric sheet and adhesive bonding of the polyurethane elastomer film to the thermoplastic sheet.

### BRIEF DESCRIPTION OF THE DRAWINGS

In drawings which illustrate an embodiment of the invention,

FIG. 1 is a block diagram illustrating consecutive steps of the preferred embodiment of a method for making a composite laminate according to the present invention;

FIG. 2 is a fragmentary sectional view of the composite laminate formed according to the embodiment of the method of this invention; and

FIG. 3 is a perspective view of an article made from the composite laminate of this invention.

### DETAILED DESCRIPTION OF THE PREFERRED EMBODIMENT

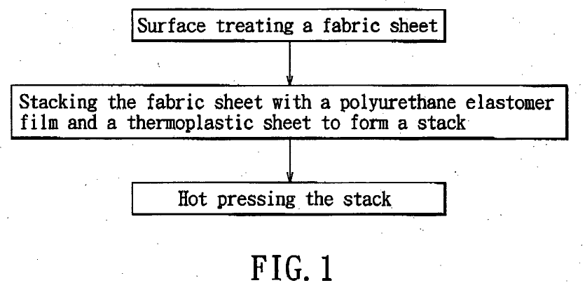

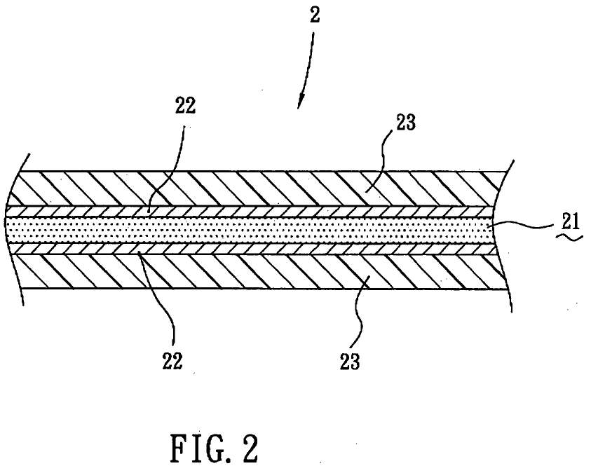

FIGS. 1 and 2 illustrate the preferred embodiment of a method for making a composite laminate 2 according to the present invention.

The method of this invention includes the steps of: surface-treating a fabric sheet 21 with an amine-containing surface agent by impregnating the fabric sheet 21 in a solution containing the amine-containing surface agent; stacking the surface-treated fabric sheet 21 with two polyurethane elastomer (TPU) films 22 and two thermoplastic sheets 23 to form a stack (see FIG. 2), each polyurethane elastomer film 22 being disposed between the fabric sheet 21 and a respective one of the thermoplastic sheets 23 (note that when only one thermoplastic sheet 23 is used, one of the polyurethane films 22 will be exposed to the atmosphere and forms a smooth surface on the fabric sheet 21); and hot pressing the stack in such a manner so as to permit penetration of each polyurethane elastomer film 22 into the fabric sheet 21, reaction of each polyurethane elastomer film 22 with the surface agent to form a —CONH bonding therebetween, and adhesive bonding of each polyurethane elastomer film 22 to the respective thermoplastic sheet 23. In this embodiment, the hot pressing is conducted at a temperature ranging from 120-180° C., a pressing pressure ranging from 2-10 Kg/cm², and a pressing time ranging from 60-250 seconds.

Preferably, each thermoplastic sheet 23 is made from a material selected from the group consisting of polyvinyl chloride, acrylonitrile-butadiene-styrene copolymer, polystyrene, polycarbonate, and polyester.

The fabric sheet 21 is preferably made from synthetic fibers, carbon fiber, and glass fiber, and is more preferably made from carbon fiber.

The amine-containing surface agent can contain monoamines, diamines, or triamines. Preferably, the amine-containing surface agent contains a diamine compound.

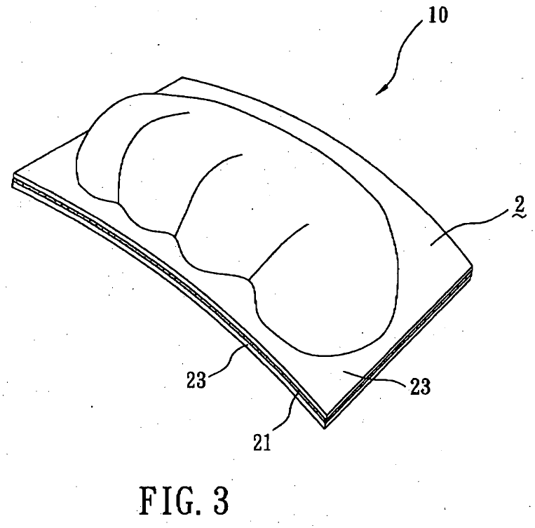

FIG. 3 illustrates an article 10 made from the composite laminate 2 of this invention. The composite laminate 2 is cut into a predetermined size, and is subsequently subjected to compression molding in a mold (not shown) under a molding temperature ranging from 100-130° C., a molding pressure ranging from 2-10 Kg/cm², and a molding time ranging from 60-180 seconds.

Since each polyurethane elastomer film 22 penetrates into the fabric sheet 21 and reacts with the surface agent to form a —CONH bonding therebetween, each thermoplastic sheet 23 can be firmly bonded to the fabric sheet 21. In addition, by hot pressing the stack according to the method of this invention, the long waiting time for drying the adhesive as required in making the conventional composite laminate and the presence of the bubbles are eliminated.

With the invention thus explained, it is apparent that various modifications and variations can be made without departing from the spirit of the present invention.

1. A composite laminate comprising:
a fabric sheet which is surface-treated with an amine-containing surface agent;
a thermoplastic sheet; and
a polyurethane elastomer film interposed between said fabric sheet and said thermoplastic sheet;
wherein said fabric sheet, said thermoplastic sheet and said polyurethane are thermally pressed to form a stack in such a manner that said polyurethane elastomer film penetrates into said fabric sheet, reacts with said surface agent to form a —CONH bonding therebetween, and is bonded to said thermoplastic sheet.

2. The composite laminate of claim 1, wherein said thermoplastic sheet is made from a material selected from the group consisting of polyvinyl chloride, acrylonitrile-butadiene-styrene copolymer, polystyrene, polycarbonate, and polyester.

3. The composite laminate of claim 1, wherein said fabric sheet is made from a material selected from the group consisting of carbon fiber and glass fiber.

4. A method for making a composite laminate, comprising the steps of:
stacking a fabric sheet, a polyurethane elastomer film and a thermoplastic sheet together to form a stack, the polyurethane elastomer film being disposed between the fabric sheet and the thermoplastic sheet; and
hot pressing the stack in such a manner so as to permit penetration of the polyurethane elastomer film into the fabric sheet and adhesive bonding of the polyurethane elastomer film to the thermoplastic sheet.

5. The method of claim 4, further comprising surface-treating the fabric sheet with an amine-containing surface agent prior to forming the stack so as to permit reaction of the polyurethane elastomer film with the surface agent upon hot perssing.

6. The method of claim 5, wherein the hot pressing is conducted at a temperature ranging from 120-180° C.

7. The method of claim 6, wherein the hot pressing is conducted at a pressing pressure ranging from 2-10 Kg/cm².

8. The method of claim 5, wherein the thermoplastic sheet is made from a material selected from the group consisting of polyvinyl chloride, acrylonitrile-butadiene-styrene copolymer, polystyrene, polycarbonate, and polyester.

9. The method of claim 5, wherein the fabric sheet is made from a material selected from the group consisting of carbon fiber and glass fiber.
